(19) United States
(12) Patent Application Publication
(10) Pub. No.: US 2016/0336684 A1
(43) Pub. Date: Nov. 17, 2016

(54) CABLE MANAGER

(71) Applicant: ACS CO., LTD, Daegu (KR)

(72) Inventors: Joung Youl KIM, Cheonan (KR); Don Hyuk CHOI, Daegu (KR); Kyung Suk KANG, Daegu (KR)

(73) Assignee: ACS CO., Ltd., Daegu (KR)

(21) Appl. No.: 14/426,945

(22) PCT Filed: Dec. 15, 2014
(86) PCT No.: PCT/KR2014/012343

§ 371 Date: Mar. 9, 2015

(30) Foreign Application Priority Data
Jan. 29, 2014 (KR) 10-2014-0011604
Jan. 29, 2014 (KR) 10-2014-0011606

(51) Int. Cl. H01R 13/629; H01R 13/627; H01R 24/64; H01R 13/518

(52) U.S. Cl. CPC H01R 13/629; H01R 13/518; H01R 13/6271; H01R 24/64; H01R 2107/00

(57) ABSTRACT

The present invention relates to a cable manager, and more particularly, to a cable manager which can secure promptness and convenience when a plurality of cables are connected or disconnected by collectively connecting and separating connectors of the cables to and from a plurality of ports formed in a socket of a server device or the like.

### TECHNICAL FIELD

The present invention relates to a cable manager, and more particularly, to a cable manager which can secure promptness and convenience when a plurality of cables are connected or disconnected by collectively connecting and separating connectors of the cables to and from a plurality of ports formed in a socket of a server device or the like.

### BACKGROUND ART

In general, a socket having a plurality of ports for the transmission of signals is formed in a server device. Several tens or several hundreds of cables for the transmission of signals are connected to the ports of the socket through the connectors.

Fastening recesses are formed in the ports formed in the socket and fastening ends are formed in the connectors of the cables inserted into the ports so that if the operator inserts the connectors of the cables into the ports of the socket, the connectors of the inserted cables fasten the fastening ends to the fastening recesses formed in the ports such that the cables are stably fixed.

However, according to the related art, because a dedicated unit for collectively connecting or separating the cable connectors inserted into the ports of the socket is not provided, the connectors of the cables should be individually separated from the ports of the socket and then be reinserted into the ports one by one so that the connectors should be connected one by one during checking or repairing of the server device, or during the replacement of the equipment.

### DETAILED DESCRIPTION OF THE INVENTION

### Technical Problem

Therefore, the present invention has been made in view of the above-mentioned problems, and an aspect of the present invention is to provide a cable manager which can secure promptness and convenience when a plurality of cables are connected or disconnected by collectively connecting and separating connectors of the cables to and from a plurality of ports formed in a socket of a server device or the like.

### Technical Solution

Accordingly, the present invention has been made to achieve the object, and it is an objective of the present invention to collectively insert connectors of cables having fastening ends into ports of a socket having fastening recesses to fix the connectors.

In accordance with an aspect of the present invention, there is provided a cable manager for collectively inserting connectors of cables having fastening ends into the ports of a socket having fastening recesses to fix the connectors, the cable manager including: a body having a plurality of fixing slots for fixing the fastening ends of the cable connectors in a non-pressed state while the fastening ends of the cable connectors protrude through openings; and a cover stacked in the fixing slots of the body, for pressing the fastening ends of the cable connectors formed on some of the cable connectors fixed to the fixing slots, respectively,

wherein, among the cable connectors fixed to the fixing slots, the connectors of the cables, of which the fastening ends are pressed by press pieces of the cover, are fixed to the ports of the socket in an unconstrained state, and the cable connectors fixed to the remaining fixing slots are configured such that the fastening ends are fastened to the fastening recesses and are fixed to the ports formed in the socket in a constrained state.

In accordance with another aspect of the present invention, there is provided a cable manager including: a body having a plurality of opened slots and closed slots for inserting connectors of cables fixed to ports formed in a socket in a constrained state by securing fastening ends to fastening recesses of the ports to fix the connectors, wherein if the connectors of the cables having the fastening ends are inserted into and fixed to the opened and closed slots and the body is inserted into the socket, the connectors of the cables are inserted into and fixed to the ports of the socket having fastening recesses on an inner wall thereof to correspond to the connectors.

### Advantageous Effects

According to the cable manager, to which the technology of the present invention is applied, because a plurality of fixing slots for collectively fixing connectors of cables are formed in a body, the connectors of the cables can be collectively inserted into, and fixed to, ports of a socket.

Accordingly, the connectors of the plurality of cables can be connected to and separated from the sockets of the socket more promptly and conveniently.

Furthermore, the connectors of the cables are usually fixed to the slots by a stepped structure and support portions formed in the cover, and the connectors can be separated and replaced through attachment and detachment of the cover.

In particular, the cover is configured such that the fastening ends of some of the cable connectors inserted into the fixing slots are pressed by press pieces.

Accordingly, some of the cable connectors fixed to the fixing slots, of which the fastening ends are pressed by the press pieces of the cover, are fixed to the ports of the socket in an unconstrained state, and the fastening ends of the cable connectors fixed to the remaining fixing slots are fastened to the fastening recesses to be fixed to the ports formed in the socket in a constrained state.

Accordingly, when the body is released from the socket, the body to which the cable connector is fixed can be conveniently separated from the socket, by pressing only the fastening ends of the cable connectors forming a constrained state with the ports without pressing the fastening ends of the connectors installed in all fixing slots.

### BRIEF DESCRIPTION OF THE DRAWINGS

FIG. 1 is an exploded perspective view of a first example illustrating a cable manager, to which the technology of the present invention is applied.

FIG. 2 is an exploded perspective view of a state in which a cable is coupled to the cable manager, to which the technology of the first example is applied.

FIG. 3 is an exploded perspective view illustrating a state in which the cable manager, to which the technology of the first example is applied, is connected to a port of a socket.

FIG. 4 is a plan view illustrating a state in which the cable manager, to which the technology of the first example is applied, is connected to the port of the socket.

FIG. 5 is a perspective view illustrating portion A extracted from the cable manager of the first example illustrated in FIG. 3.

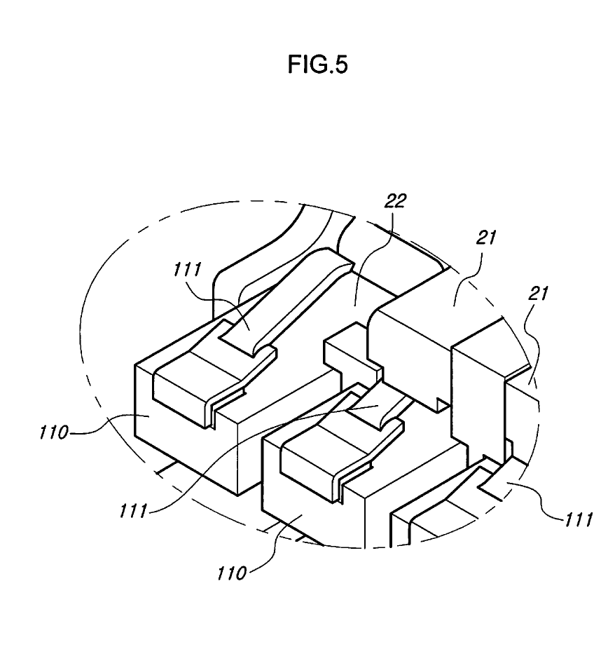

FIG. 6 illustrates sectional views taken along line A-A of the cable manager of the first example illustrated in FIG. 4, in which FIG. 6A illustrates a separated state and FIG. 6B illustrates a coupled state.

FIG. 7 illustrates sectional views taken along line B-B of the cable manager of the first example illustrated in FIG. 4, in which FIG. 7A illustrates a separated state and FIG. 7B illustrates a coupled state.

FIG. 8 is an exploded perspective view of a second example illustrating a cable manager, to which the technology of the present invention is applied.

FIG. 9 is an exploded perspective view illustrating a state in which the cable manager, to which the technology of the second example is applied, is connected to a port of a socket.

FIG. 10 is a plan view illustrating a state in which the cable manager, to which the technology of the second example is applied, is connected to the port of the socket.

FIG. 11 is a perspective view illustrating portion A extracted from the cable manager of the second example illustrated in FIG. 9.

FIG. 12 illustrates sectional views taken along line A-A of the cable manager of the second example illustrated in FIG. 10, in which FIG. 12A illustrates a separated state and FIG. 12B illustrates a coupled state.

FIG. 13 illustrates sectional views taken along line B-B of the cable manager of the second example illustrated in FIG. 10, in which FIG. 13A illustrates a separated state and FIG. 13B illustrates a coupled state.

### MODE FOR CARRYING OUT THE INVENTION

The present invention provides a cable manager for collectively inserting connectors of cables having fastening ends into ports of a socket having fastening recesses to fix the connectors, the cable manager including: a body having a plurality of fixing slots for fixing the fastening ends of the cable connectors in a non-pressed state while the fastening ends of the cable connectors protrude through openings; and a cover stacked in the fixing slots of the body, for pressing the fastening ends of the cable connectors formed some of the cable connectors fixed to the fixing slots, respectively, wherein, among the cable connectors fixed to the fixing slots, the connectors of the cables, of which the fastening ends are pressed by press pieces of the cover are fixed to the ports of the socket in an unconstrained state, and the cable connectors fixed to the remaining fixing slots are configured such that the fastening ends are fastened to the fastening recesses and are fixed to the ports formed in the socket in a constrained state.

The present invention also provides a cable manager including: a body having a plurality of opened slots and closed slots for inserting connectors of cables fixed to ports formed in a socket in a constrained state by securing fastening ends to fastening recesses of the ports to fix the connectors, wherein if the connectors of the cables having the fastening ends are inserted into and fixed to the opened and closed slots and the body is inserted into the socket, the connectors of the cables are inserted into and fixed to the ports of the socket having fastening recesses on an inner wall thereof to correspond to the connectors.

The cable manager 1, to which the technology of the present invention is applied, is a dedicated device for collectively connecting and separating connectors 110 of a plurality of cables 100 to and from ports 210 of a socket 200 formed in a server device or the like.

Fastening ends 111 are formed in the connectors 110 of the cables 100, which are collectively connected according to an embodiment of the present invention, and the fastening ends 111 are fixedly fastened to fastening recesses 211 formed in the ports 210 of the socket 200. These types of cables are general ones, which are utilized as LAN cables.

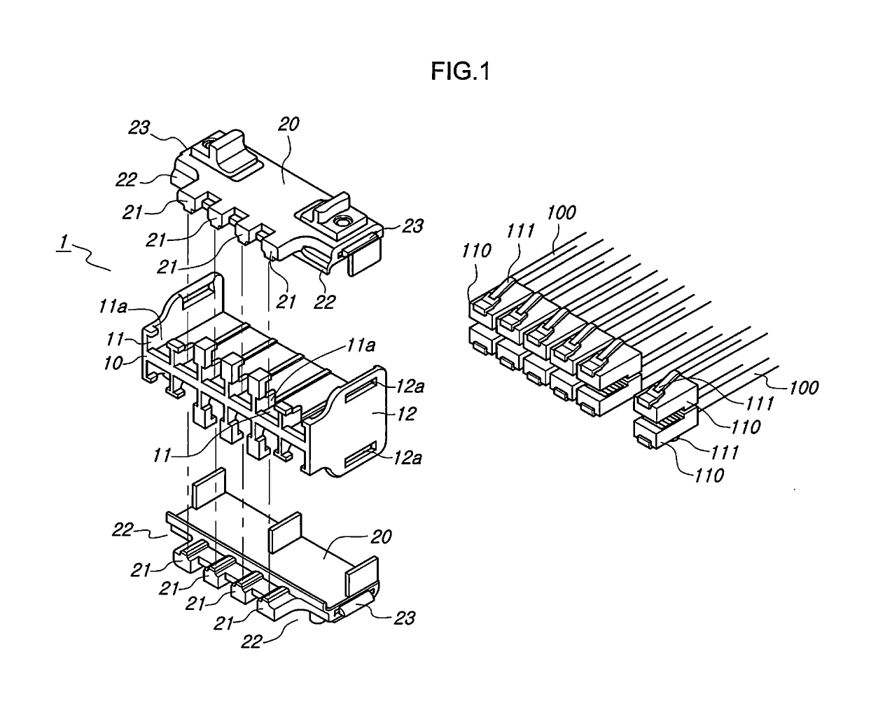

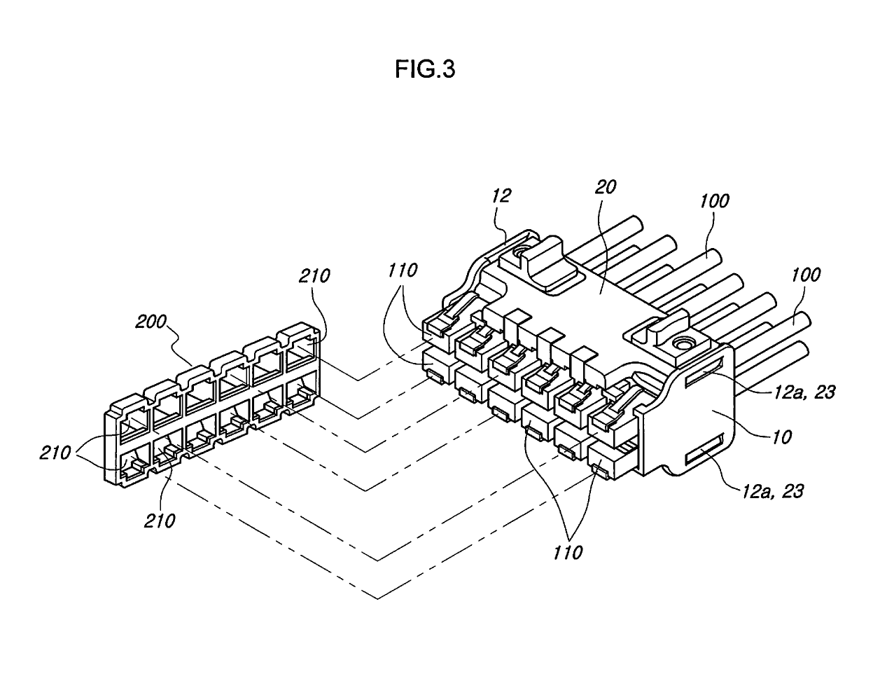

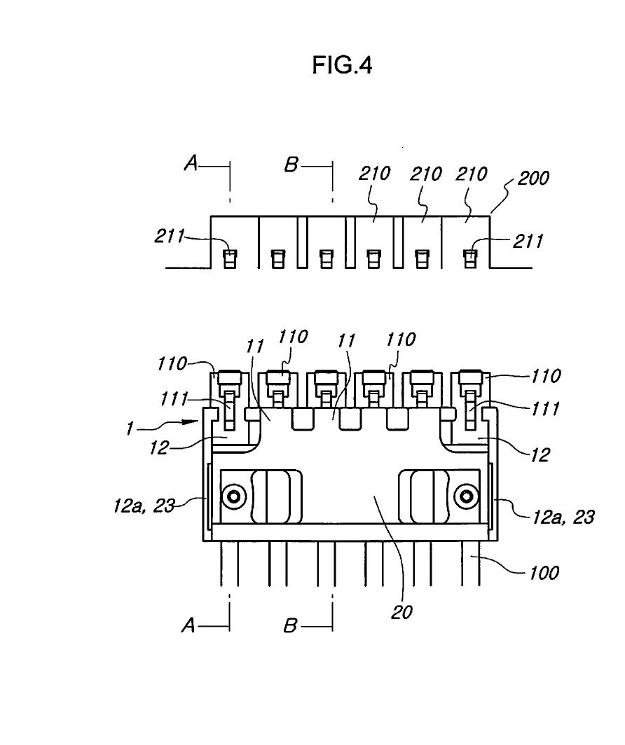

As illustrated in FIGS. 1 to 4, the cable manager 1 for collectively fixing the connectors 110 of the general cables 100 such that the connectors 110 are collectively connected and released to and from the ports 210 of the socket 200 includes a body 10 having a plurality of fixing slots 11, into which the connectors 110 of the cable 100 are fixedly inserted.

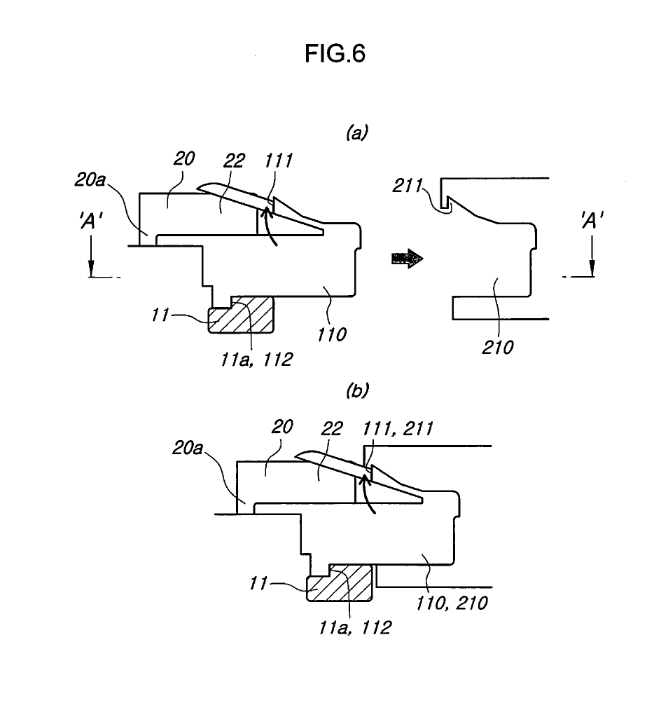

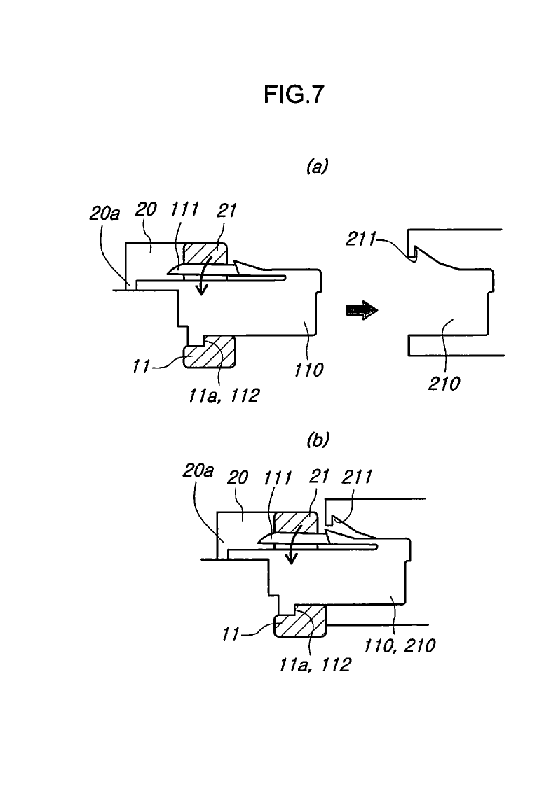

In the present embodiment, fixing slots 11, to which the connectors 110 of the cable 100 are fixed respectively, are formed in the body 10 to be vertically symmetrical, and a cover 20 is stacked on the body 10. Referring to FIGS. 6 and 7 corresponding to the exemplary embodiment of the present invention, support portions 11a for restricting insertion depths of the connectors 110 of the cable 100 are formed in the fixing slots 11, respectively, and the connectors 110 of the cables inserted into the fixing slots 11 are supported by the support portions 11a through stepped portions 112 with a step structure to protrude to the front side of the fixing slots 11 by a predetermined length.

The cover 20 for collectively supporting the rear sides of the connectors 110 of the cables 100 inserted into the fixing slots 11 through a support step 20a is stacked in the body 10, so that the rear sides of the connectors 110 of the cables 100 inserted into the fixing slots 11 and supported by a step structure are collectively supported by the support step 20a formed in the cover 20.

In the present embodiment, fixing pieces 12 having fixing recesses 12a are formed at opposite sides of the body 10 to be spaced apart from each other to the left and right sides, so that the cover 20 is inserted between the fixing pieces 12 to be stacked in the fixing slots 11.

Then, as illustrated in FIGS. 1 to 4, sliders 23 resiliently supported by a spring are installed at opposite sides of the cover 20 to have a retractable structure, and the cover 20 inserted between the fixing pieces 12 inserts the sliders 23 into the fixing recesses 12a to be fastened and fixed to the fixing pieces 12 while being stacked in the fixing slots 11.

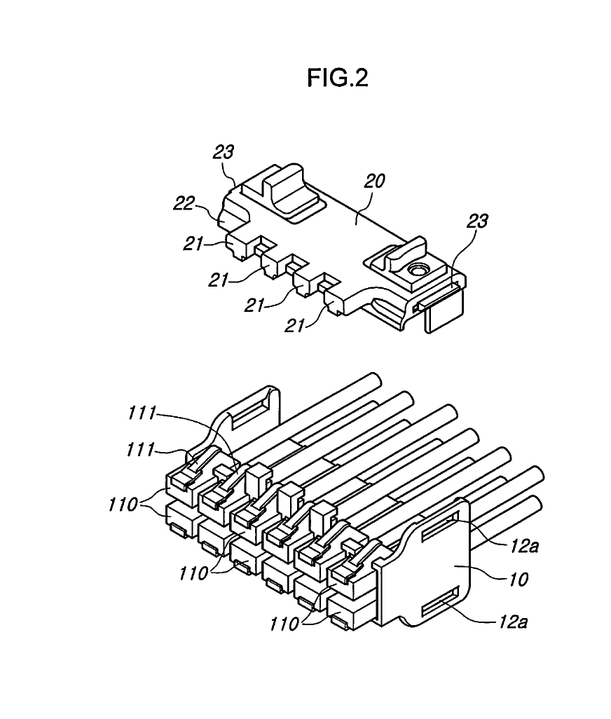

Accordingly, as illustrated in FIG. 2, if the operator inserts the connectors 110 of the cables 100 into the fixing slots 11 formed in the body 10 and fixes the connectors 110, fixedly stacks the cover 20 in the fixing slots 11 of the body 10, and collectively fixes the connectors 110 of the cables 100 into the ports 210 of the socket 200, the fastening ends 111 of the connectors 110 are fastened to the fastening recesses 211 formed in the ports 210 such that the connectors 110 of the cables 100 are inserted into and fixed to the ports 210.

Furthermore, if the operator presses the fastening ends 111 of the connectors 110 to release the fastening of the ports 210 due to the fastening ends 111, the connectors 110 of the cables 100 are separated from the ports 210.

Meanwhile, according to the present embodiment, the number of the connectors 110 of the cables 100 fixed to the fixing slots 11 of the body 10 is minor, for example, 3 or 4, the fastening ends 111 of the connectors of the cables fixed to the fixing slots are simultaneously pressed, so that the constraint of the ports and the connectors may be released.

However, in the present embodiment, the number of the fixing slots 11 and the connectors 110 of the cables 100 fixed to the fixing slots 11 is more than 3 or 4, the operator simultaneously presses the fastening ends 111 formed in the connector 110, so that it is actually difficult to collectively release the constraint between the ports 210 and the connectors 110.

In this aspect, press pieces 21 for pressing the fastening ends 111 of the connectors 110 of the cables fixed to some of the fixing slots 11 of the body 10, among the cable connectors 110 fixed to the fixing slots 11 of the body 10, are formed in the cover 20, so that the fastening ends 111 of the cable connectors 110 fixed to some of the fixing slots 11, among the cable connectors 110 fixed to the fixing slots 11, are pressed by the press pieces 21 formed in the cover 20.

In more detail, in the present invention, the fastening ends 111 of the cable connectors 110 inserted into the fixing slots 11 through the openings 11a formed at upper portions of the fixing slots 11 protrude upwards, so that the open-topped fixing slots 11 for fixing the fastening ends 111 of the cable connectors 110 while the fastening ends 111 are not pressed are formed in the body 10.

Press pieces 21 for pressing the fastening ends 111 of the cable connectors 110 formed in some of the fixing slots 11 are formed in the cover 20 stacked in the fixing slots 11, so that the cover 20 is stacked in the body 10, the press pieces 21 are inserted along the openings 11a of the fixing slots 11 formed on the lower side to press the fastening ends 111 of the cable connectors 110.

Referring to the drawings illustrating the exemplary embodiment of the present invention, opening recesses 22 communicated with the openings 11a of the fixing slots 11 formed at opposite sides of the body are formed at opposite sides of the cover 20, and press pieces 21 for pressing the fastening ends 111 of the cable connectors 110 fixed to the fixing slots 11, respectively, are formed inside the opening recesses 22.

Accordingly, if the cover 20 is fixedly stacked in the fixing slots 11 formed in the body 10, the fastening ends 111 of the cable connectors 110 fixed to the fixing slots 11 formed at opposite peripheries of the body 10 form a non-pressed state, and the fastening ends 111 of the cable connectors 110 fixed to the fixing slots 11 formed inside the opening recesses 22 are pressed by the press pieces 21, respectively, as illustrated in FIG. 7.

In addition, the operator inserts the connectors 110 of the cables into the fixing slots 11 formed in the body 10, respectively, to stack and fix the cover 20, and inserts the body 10 into the socket 200 to collectively insert the connectors 110 of the cables inserted into the fixing slots 11 into the ports 210 of the socket 200.

Then, as illustrated in FIG. 7B, the cable connectors 110 fixed to the fixing slots 11, such that the fastening ends 111 are pressed by a press end 21 of the cover 20, are connected to the corresponding slots 210 in a non-constraint state, and as illustrated in FIG. 6B, the cable connectors 110 fixed to the fixing slots 11 such that the fastening ends 111 is not pressed are fastened to the fastening recesses 211 formed in the corresponding ports 210 to be fixed to the corresponding ports 210 while being constrained.

That is, the body 10 in which the cable connectors 110 are inserted into the fixing slots 11, respectively, is configured such that all the cable connectors 110 are not constrained and fixed by the ports of the socket 200 and are stably fixed to the socket 200 through a constraint between the cable connector 110 which is not pressed by the press pieces 21 of the cover 20 and the ports 210.

Accordingly, when the socket 200 and the cable connectors 110 are collectively disconnected through the cable manager 1, the cable connectors 110 and the ports 210 are separated from each other if the operator presses the fastening pieces 111 of the cable connectors 110 protruding to the openings 11a of the fixing slots 11 through the opening recesses 22 formed in the cover 20, and as a result, the body to which the cable connectors are usually fixed and the socket having the ports are collectively separated.

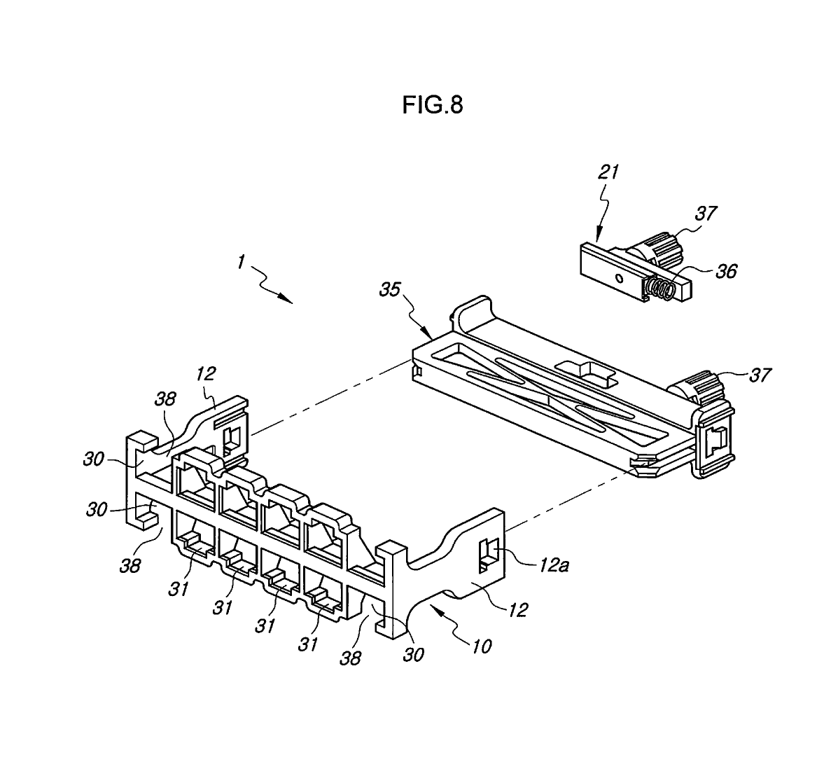

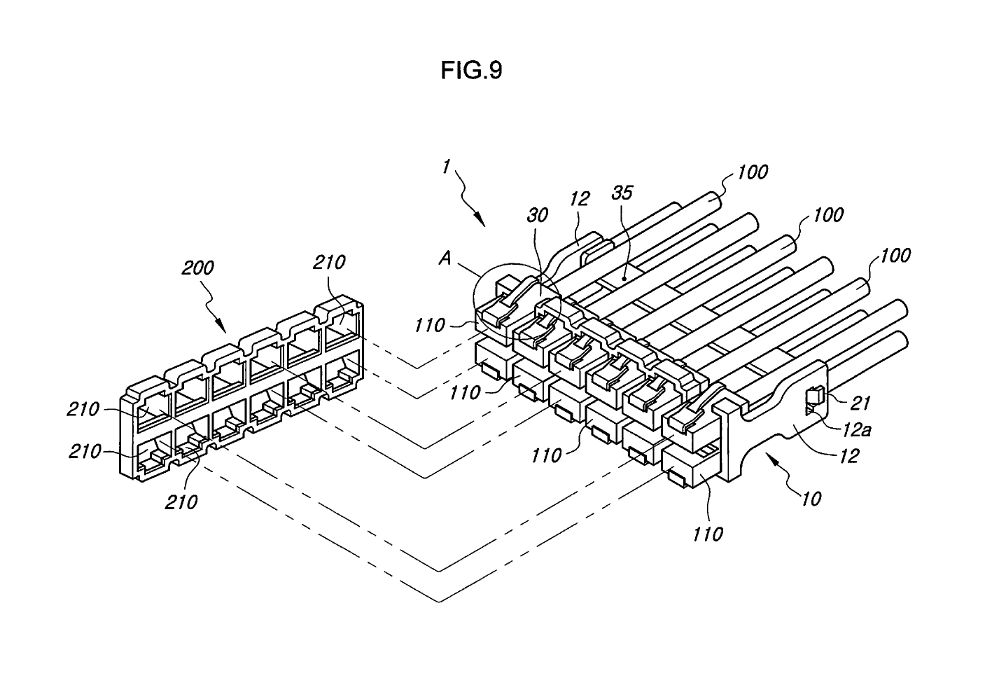

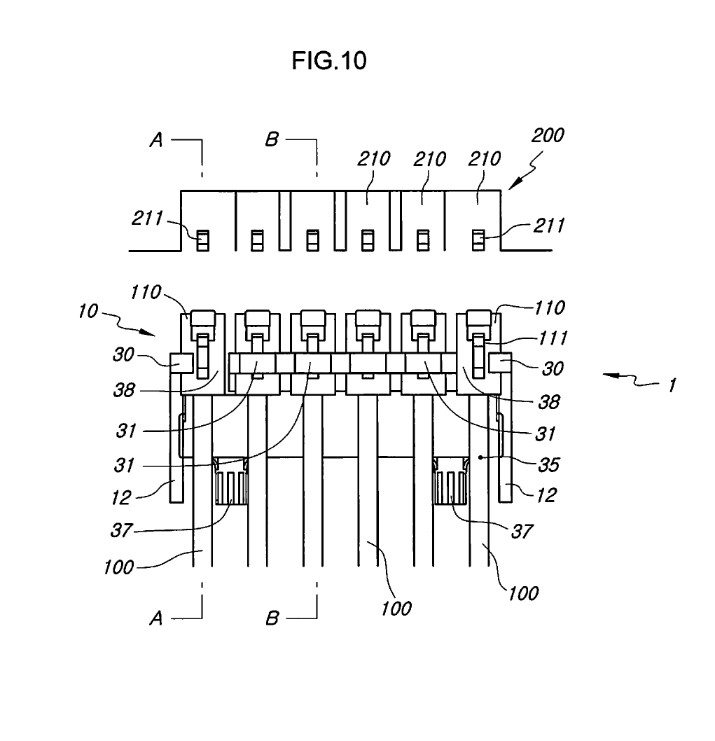

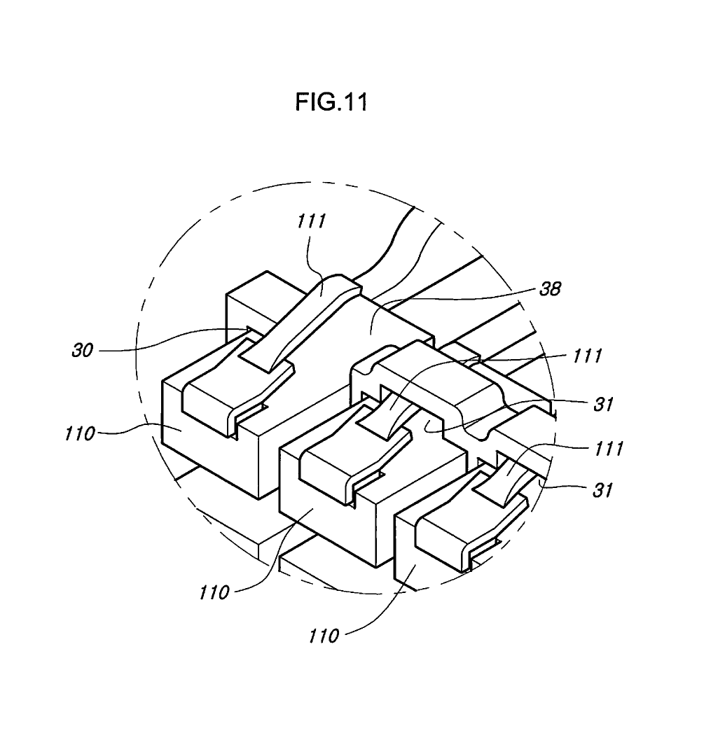

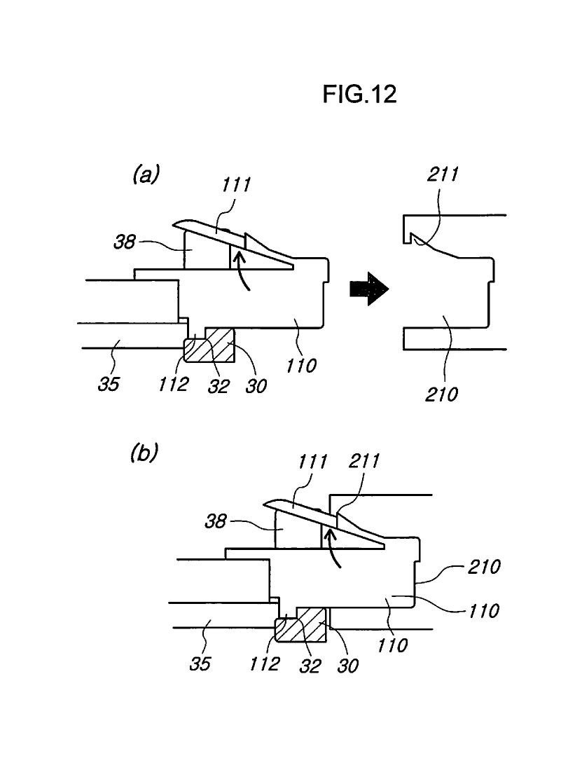

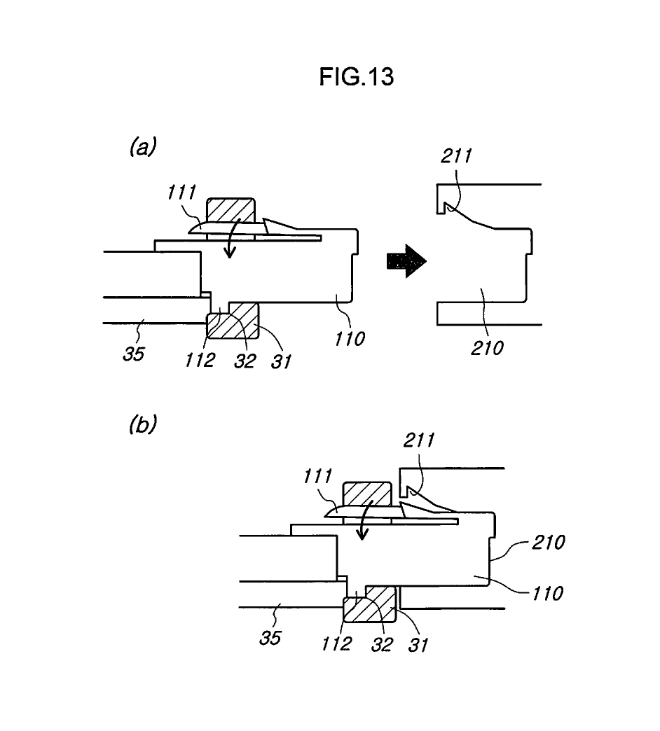

Hereinafter, the cable manager 1 to which the second example of the present invention is applied will be described with reference to the drawings, in which FIG. 8 is an exploded perspective view of a second example illustrating a cable manager, to which the technology of the present invention is applied, FIG. 9 is an exploded perspective view illustrating a state in which the cable manager, to which the technology of the second example is applied, is connected to a port of a socket, FIG. 10 is a plan view illustrating a state in which the cable manager, to which the technology of the second example is applied, is connected to the port of the socket, FIG. 11 is a perspective view illustrating portion A extracted from the cable manager of the second example illustrated in FIG. 9, FIG. 12 illustrates sectional views taken along line A-A of the cable manager of the second example illustrated in FIG. 10, in which FIG. 12A illustrates a separated state and FIG. 12B illustrates a coupled state, and FIG. 13 illustrates sectional views taken along line B-B of the cable manager of the second example illustrated in FIG. 10, in which FIG. 13A illustrates a separated state and FIG. 13B illustrates a coupled state.

The cable manager 1, to which the second example of the present invention is applied, two rows of opened slots 30 and closed slots 31, to which the connectors 110 of the cable 100 are fixed, respectively, are vertically formed in the body 10.

Referring to the drawings illustrating the exemplary embodiment of the present invention, the front and rear sides of the opened and closed slots 30 and 31 formed in the body 10 are opened, and the cable connectors 110 may be fixed to the opened and closed slots 30 and 31 through resilient fastening or interference-fitting.

Meanwhile, in the present embodiment, the connectors 110 of the cables 100 fixed to the opened and closed slots 30 and 31 of the body 10 may be attached and detached, such that the operator adds an attachment structure that allows the connectors 110 of the cables 100 to be separated from or installed again in the opened and closed slots 30 and 31.

To achieve this, in the present embodiment, as illustrated in FIGS. 12 and 13, support portions 32 for restricting the insertion depths of the connectors 110 of the cables 100 are formed in the opened and closed slots 30 and 31 formed in the body 10 such that the stepped portions 112 of the connectors 110 inserted into the opened and closed slots 30 and 31 are supported by the support portions 32 with a stepped structure, so that front parts of the connectors 110 of the cables 100 inserted into the opened and closed slots 30 and 31 usually protrude to the front sides of the opened and closed slots 30 and 31 by a predetermined length.

Support members 35 for collectively supporting the rear sides of the connectors 110 of the cables 100 inserted into the opened and closed slots 30 and 31 is further installed in the body 10, so that the rear sides of the connectors 110 of the cables 100 inserted into the opened and closed slots 30 and 31 and supported by the stepped structure are collectively supported by the support members 35.

In the present embodiment, the support members 35 are detachably installed in the body 10, so that the connectors 110 of the cables 100 fixed to the opened and closed slots 30 and 31 may be separated and replaced through attachment and detachment of the support members 35.

In detail, as illustrated in FIGS. 8 and 10, in the present embodiment, the fixing pieces 12 having the fixing recesses 12a are formed at opposite sides of the body 10 to be spaced apart from each other to the left and right sides, and sliders 23 resiliently supported by springs 36, having a knob 37 for movement, and protruding to opposite sides are installed in the support members 35, respectively.

As will be described below, the sliders 23 resiliently fastened to the fixing recesses 12a may be replaced by fixing bosses (not illustrated), which also fall within the scope of the present invention.

Accordingly, if the operator individually inserts the connectors 110 of the cables 100 having the stepped portions 112 into the opened and closed slots 30 and 31 formed in the body 10 and the support members 35 are inserted between the fixing pieces 12 formed in the body 10, the rear sides of the connectors 110 of the cables 100 inserted into the opened and closed slots 30 and 31 are supported by the support members 35, so that the cable connectors 110 inserted into the opened and closed slots 30 and 31 are usually fixed to the opened and closed slots 30 and 31, respectively.

Through the process, the cable manager 1 in which the plurality of cable connectors 110 are usually fixed to the opened and closed slots 30 and 31 is inserted into the socket 200 in which the ports 210 are formed in correspondence, the connectors 110 of the cables 100 usually fixed to the opened and closed slots 30 and 31 of the body 10 are collectively inserted into and connected to the ports 210 formed in the socket 200.

Then, the cable connectors 110 fixed to the opened and closed slots 30 and 31 of the cable manager 1 and inserted into the ports 210 of the socket 200 fasten the fastening ends 111 to the fastening recesses 211 formed in the socket 200 to stably fix the body 10 of the cable manager 1, to which the connectors 110 of the cables 100 are fixed, and the socket 200 having the ports 210.

If the fastening ends 111 fastened to the fastening recesses 211 are pressed and the body 10 is separated from the socket 200, the ports 210 formed in the sockets 200 and the connectors 110 of the cables fixed to the cable manager 1 are collectively released.

Accordingly, because the cable manager 1 according to the present invention may collectively connect and separate the plurality of cables 100 to and from the ports 210 of the socket 200, a troublesomeness of the operator individually connecting and separating the connectors 110 of the cables 100 to and from the ports 210 of the socket 200 can be solved and the cables 100 can be promptly connected and separated.

Furthermore, after the support members 35 are separated from the body 10, the cable connectors 110 inserted into and fixed to the opened and closed slots 30 and 31 can be detached such that the locations of the cable connectors 110 are changed, or new cable connectors 110 can be fixed to the opened and closed slots 30 and 31.

Meanwhile, the number of the cable connectors 110 fixed to the cable manager is minor, that is, 3 or 4, the user can press the fastening ends 111 of the cable connectors, but when the number of the cable connectors is more than 3 or 4, it is actually difficult to simultaneously press the fastening ends formed in the connectors and release the constraint between the ports and the connectors.

Accordingly, when the cable connectors 110 are collectively separated from the ports 210 of the socket 200 through the cable manager 1, a troublesomeness of simultaneously and individually pressing the fastening ends 111 fastened to the fastening recesses 211 of the ports 210 occurs.

In this aspect, in the present embodiment, as illustrated in FIGS. 8 to 13, the closed slots 31 for pressing the fastening ends 111 of the cable connectors 110 inserted into and fixed to the body 10 to offset the fastening function of the fastening ends 111 and the opened slots 30 that do not press the inserted and fixed fastening ends 111 of the cable connectors 110 may be used together.

Referring to the drawings illustrating the exemplary embodiment of the present invention, the closed slots 31 have an annular body as illustrated in FIGS. 8 to 10 to fix the fastening ends 111 of the cable connectors 110 inserted into the interiors of the closed slots 31 while the fastening ends 111 being pressed, and the opened slots 30 formed together has a C-shaped body having an opening 38 such that the fastening ends 111 of the cable connector 110 inserted into the interior of the opened slots 30 through the openings 38 to the outside to form a non-pressed state.

Accordingly, if the body 10 is inserted into the socket 200 such that the connectors 110 inserted into the opened and closed slots 30 and 31 are collectively inserted into the ports 210 of the socket 200 as illustrated in FIG. 10 after the connectors 110 of the cables are inserted into and fixed to the closed slots 31 and the opened slots 30 formed in the body 10, the cable connectors 110 inserted into the closed slots 31 form an unconstrained state with the corresponding ports 210 as illustrated in FIG. 13, and the connectors 110 of the cables inserted into the opened slots 30 fasten the fastening ends 111 to the fastening recesses 211 formed in the corresponding ports 210 to fix the fastening ends 111 to the corresponding ports 210 in a constrained state as illustrated in FIG. 12.

That is, the body 10 in which the cable connectors 110 are inserted into the opened and closed slots 30 and can be stably fixed to the socket 200 by the constraint between the connectors 110 of the cables inserted into the opened slots 30 and the corresponding ports 210.

Accordingly, when the socket 200 and the cable connectors 110 are collectively disassembled through the cable manager 1, the socket 200 and the body 10 can be stably fixed by locally fixing the cable connectors 110 fixed to the opened slots 30 and the ports 210 formed in the sockets 200.

In addition, the cable connectors 110 fixed to the cable manager 1 and the ports 210 formed in the socket 200 can be collectively separated by pressing the fastening ends 111 formed in the cable connectors 110 fixed to the opened slots 30.

### INDUSTRIAL APPLICABILITY

Connectors of cables can be collectively and promptly connected and separated to and from a plurality of ports formed in the socket such as a server device, and the technology can be combined with the technical field, such as various connectors, improving convenience of use.

1. A cable manager for collectively inserting connectors of cables having fastening ends into ports of a socket having fastening recesses to fix the connectors, the cable manager comprising:
a body having a plurality of fixing slots for fixing the fastening ends of the cable connectors in a non-pressed state while the fastening ends of the cable connectors protrude through openings; and
a cover stacked in the fixing slots of the body, for pressing the fastening ends of the cable connectors formed some of the cable connectors fixed to the fixing slots, respectively,
wherein, among the cable connectors fixed to the fixing slots, the connectors of the cables, of which the fastening ends are pressed by press pieces of the cover are fixed to the ports of the socket in an unconstrained state, and the cable connectors fixed to the remaining fixing slots are configured such that the fastening ends are fastened to the fastening recesses and are fixed to the ports formed in the socket in a constrained state.

2. A cable manager comprising:
a body having a plurality of opened slots and closed slots for inserting connectors of cables fixed to ports formed in a socket in a constrained state by securing fastening ends to fastening recesses of the ports to fix the connectors,
wherein if the connectors of the cables having the fastening ends are inserted into and fixed to the opened and closed slots and the body is inserted into the socket, the connectors of the cables are inserted into and fixed to the ports of the socket having fastening recesses on an inner wall thereof to correspond to the connectors.

3. The cable manager of claim 1, wherein the cover has opening recesses for exposing fastening pieces fixed to the fixed slots to protrude through openings, so that the operator temporarily presses the fastening pieces through press recesses to release the constraint between the ports and the connectors.

4. The cable manager of claim 1, wherein the fixing slots formed in the body have support portions for restricting the insertion depths of the cable connector, respectively, such that the connectors inserted into the fixing slots are configured such that stepped portions are supported by the support portions with a stepped structure, and the cover has a support step for collectively supporting the rear sides of the cable connectors inserted into the fixing slots, respectively.

5. The cable manager of claim 1, wherein support pieces having fixing recesses are formed at opposite sides of the body to be spaced apart from each other to the left and right sides and sliders are installed at opposite sides of the cover in a retractable structure such that the cover inserted between the support pieces and stacked in the fixing slots is configured to insert the sliders into the fixing recesses and fix the sliders between the support pieces.

6. The cable manager of claim 2, wherein the closed slots for pressing the fastening ends of the cable connectors inserted into and fixed to the body to offset the fastening function of the fastening ends and the opened slots that do not press the inserted and fixed fastening ends of the cable connectors are formed in the body, such that if the body is inserted into the socket in which the ports are formed to correspond to the connectors of the cables after the connectors are fixed to the closed slots and the opened slots, the connectors of the cables inserted into the closed slots are fixed to the closed slots in an unconstrained state and the connectors of the cables inserted into the opened slots are fixed to the ports in a constrained state by fastening the fastening ends to the fastening recesses, so that the body is locally fixed to the socket through the constraint between the connectors of the cables inserted into the opened slots and the inserted ports and the body is separated from the socket if the constraint is released by pressing the fastening ends of the inserted cable connectors to the opened slots.

7. The cable manager of claim 2, wherein the closed slots have an annular body, and the fastening ends of the cable connectors inserted into the closed slots are fixed to inner walls of the closed slots in a pressed state.

8. The cable manager of claim 2, wherein the opened slots have a C-shaped body having an opening, and the cable connectors inserted into the opened slots are exposed through openings such that the fastening ends are fixed in a non-pressed state.

9. The cable manager of claim 2, wherein support portions for restricting the insertion depths of the cable connectors are formed in the opened and closed slots formed in the body, and the connectors inserted into the opened and closed slots are supported by stepped portions and the support portions with a stepped structure.

10. The cable manager of claim 2, wherein support members for collectively supporting the rear sides of the connectors of the cables inserted into the opened and closed slots are further installed in the body, so that the connectors of the cables inserted into the opened and closed slots are fixed to the opened and closed slots while the rear sides of the connectors are supported by the support members.

11. The cable manager of claim 2, wherein fixing pieces are formed at opposite ends of the body to be spaced apart from each other to the left and right sides, and support members for collectively supporting the cable connectors inserted into the opened and closed slots are fixed between the fixing pieces.
